(19) United States
(12) Patent Application Publication
(10) Pub. No.: US 2025/0283515 A1
(43) Pub. Date: Sep. 11, 2025

(54) CLUTCH SYSTEM FOR A DISTRIBUTION CONTROL SYSTEM IN A FLUID(S) CIRCUIT

(71) Applicant: BONTAZ CENTRE, MARNAZ (FR)

(72) Inventors: Adrien PLEUHS, ANNECY (FR); Lucas BALLET-BAZ, PASSY (FR); Hugo FIEGEL, MARIGNIER (FR); Julie MANDON, Bonneville (FR)

(21) Appl. No.: 18/850,100

(22) PCT Filed: Mar. 23, 2023
(86) PCT No.: PCT/FR2023/050416

§ 371 Date: May 27, 2025

(30) Foreign Application Priority Data
Mar. 24, 2022 (FR) FR2202658

(51) Int. Cl. F16D 27/118; F16K 31/04; F16K 31/53

(52) U.S. Cl. CPC F16D 27/118; F16K 31/047; F16K 31/535; F16D 2500/5012

(57) ABSTRACT

A system for controlling the distribution of fluids in a fluid circuit, comprises a motor; a plurality of d rotary distributors of the fluid; and a plurality of d gear trains, each train transmitting the movement from the motor to one of the rotary distributors. Each gear train comprises actuators for engaging or disengaging a gear of this train, or the associated rotary distributor, relative to the gear train. The actuators comprise a rotary drive device for a rotary member equipped with an output shaft. The drive device comprises a gear wheel, rotating about a rotation shaft aligned with the output shaft; an actuator for actuating the rotation shaft of the gear wheel towards the output shaft of the rotary member; a guide of the gear wheel to guide the translation movement thereof along the rotation shaft; and a clutch of the rotation shaft and of the output shaft.

### TECHNICAL FIELD AND PRIOR ART

The invention relates to the field of managing one or more fluids for example water and/or oil in communicating or independent thermal management systems, for example used for heating or cooling sub-systems in an electrified or not motor vehicle, such as electrochemical storage systems, motor(s), converters, etc.

Currently, controlling the flow of fluid such as water in a cooling circuit of a vehicle may be performed by:
a set of motorised actuators and of On/Off valves;
or multi-inlet-multi-outlet valves;
or independent regulation modules with one or more actuators.

These systems must be connected to one another most of the time using pipes that may be expensive and heavy. These systems require managing the fluid(s) by area with a control that is often complex.

Therefore, the problem arises of finding a system or a device for driving a rotary member or for controlling such a device or a system that contains it, that is simpler, whether this concerns for example an application to a cooling circuit or to another fluid circuit (or hydraulic circuit).

In addition, the problem arises of finding a device or system for managing or controlling the distribution of one or more fluids in a fluid circuit, that is simpler than the known systems, and that can be applied to various types of fluids (glycol water, oil, dielectric fluid, hydrogen, air).

In addition, the problem arises of finding a novel device for distributing one or more fluids, capable of being integrated into a distribution system, and that can be applied to various types of fluids (glycol water, oil, dielectric fluid, hydrogen, air).

In addition, the problem arises of finding a novel rotary drive device for a rotary member, for example for a rotary distributor in view of distributing one or more fluids and/or for a gear wheel of a gear, for example in a system for distributing one or more fluids. Such a rotary drive device preferably comprises a clutch and clutch release mechanism, for driving for example this rotary distributor.

### DISCLOSURE OF THE INVENTION

The invention firstly relates to a rotary drive device for a rotary member equipped with an output shaft, said drive device comprising:
a gear wheel, rotating about a rotation shaft aligned with the output shaft;
an actuator for actuating the rotation shaft of the gear wheel towards the output shaft of said rotary member;
guide means of the gear wheel so as to guide the translation movement thereof along the rotation shaft;
clutch means of the rotation shaft and of the output shaft comprising a coupling device using teeth and grooves.

In one example, the rotary member may be rotated in a plane that is perpendicular to the output shaft thereof.

Such a device according to the invention may further comprise return means for holding the clutch means of the rotation shaft and of the output shaft in the disengaged position; for example, said actuator compresses these return means to engage the rotation shaft and the output shaft.

The return means may be disposed at least partly in a compartment one end of which is equipped with a part of the clutch means.

Said actuator is for example of the electromagnetic actuator type, comprising a coil and a plunger that interacts with the field generated by the coil when a current flows through the latter, in order to compress the return means.

In a rotary drive device according to the invention:
said guide means of the gear wheel may comprise a bearing that guides the inner surface of the wall of the gear wheel (or that is equipped with teeth);
and/or said actuator may be of the electromagnetic or pneumatic or hydraulic type; if it is of the electromagnetic type, it may comprise a coil and a plunger that interacts with the field generated by the coil when a current flows through the latter;

A rotary drive device according to the invention may further comprise:
means for driving the wheel, forming with the latter a vertical shaft gear;
and/or braking means for braking the rotary member or the gear wheel when the latter is disengaged.

In one example of device according to the invention, the rotary member comprises a gear wheel, which may preferably be rotated in a plane that is perpendicular to the output shaft thereof.

In another example of device according to the invention, the rotary member comprises a rotary distributor, which may preferably be rotated in a plane that is perpendicular to the output shaft thereof.

The invention also relates to a distributor comprising a rotary distributor body, comprising at least one inlet and at least one outlet, the sum of the number of inlets and of the number of outlets being greater than or equal to 3, an output shaft and a rotary drive device according to the invention, as described above or in the remainder of the present application. The rotary distributor may preferably be rotated in a plane that is perpendicular to the output shaft.

The invention also relates to a system for controlling the flow of at least one fluid in a hydraulic circuit, comprising:
a motor, for example a brushless motor or a stepper motor;
a plurality of d distributors (D₁-D_{d}) of said fluid;
a plurality of d gear trains, each train transmitting the movement from the motor to one of the distributors, each gear train comprising means for directly engaging or disengaging the associated distributor or a gear of this train, these means for engaging or disengaging a gear of this train, or the associated rotary distributor, comprising at least one device according to the invention.

Such a system is simpler than the known systems since the same motor can actuate various distributors.

Each gear train may comprise:
a first gear stage (E_{1.1}-E_{1.d}), each gear of which is driven by said motor;
a second gear stage (E_{2.1}-E_{2.d}), each gear of which is driven by the first stage.

For example:
in the first gear stage (E_{1.1}-E_{1.d}), each gear of this first stage may be driven by said motor and be associated with a disengageable shaft (A_{1.1}-A_{1.d}) and/or with a clutch release means;
a second gear stage (E_{2.1}-E_{2.d}), each gear of which is driven by a gear, or a shaft associated with a gear, of the first gear stage.

A system according to the invention makes it possible to orient the flow of a fluid, for example water, via d distributors controlled independently by the same motor. For example, this fluid comes from p pumps is distributed using m inlets (the sum of the number of inlets of all of the distributors) and n outlets (the sum of the number of outlets of all of the distributors of the system).

According to particular embodiments:
each distributor (Dᵢ) may comprise nₑᵢ inlets and nₛᵢ outlets;
and/or each distributor (Dᵢ) may comprise or be associated with a position sensor (C₁-C);
and/or the system may comprise electronic means for controlling the motor; in even more particular embodiments, these electronic means are capable of:
controlling the motor depending on a signal or signals from one or more of said position sensors (C₁-C_{d})
and/or of:
receiving an operating mode instruction;
determining a target displacement of each of the d distributors;
controlling the motor depending on the target displacement of each of the distributors.

According to particular embodiments, each shaft:
is associated with a solenoid for engaging it or disengaging it;
and/or may be held in idle position by a compression spring (R₁, . . . R_{d}).

A system for distributing one or more fluids according to the invention, in a fluid circuit, may comprise:
at least one pump;
a system for controlling the distribution of said fluid according to the invention, as defined above or in the present application.

Such a distribution system may for example comprise one or more systems for a thermal energy exchange.

The invention also relates to a vehicle comprising:
an engine, combustion and/or electric, that may for example comprise at least one electrochemical storage system and a converter;
at least one fluid circuit and at least one system for distributing, according to the invention, a fluid in this fluid circuit, as defined above or in the present application.

The invention also relates to a method for controlling the distribution of at least one fluid in a hydraulic circuit, implementing a system according to the invention, as described above or in the present application.

Preferably, such a method comprises:
determining and/or selecting one or more distributors to be actuated;
actuating said distributor(s) using the motor.

An instruction or a control signal may be received beforehand, defining an operating mode, or a combination of distributor positions to be reached in order to distribute the fluid according to what is desired or defined by the instruction or the signal.

The position of one or more distributors may be known via a measurement, for example by one or more position sensor(s) associated with one or more distributor(s).

According to one embodiment, the fluid(s) may be water, but other fluids may be concerned, for example oil, dielectric fluids, or a mixture comprising glycol or a gas, for example air or hydrogen.

In one device or one method according to the invention, the hydraulic circuit may be for example a circuit for distributing a fluid in a circuit for thermal management, heating or cooling or a circuit for distributing oil or hydrogen or air of a vehicle or of a device, for example of the domestic type such as a heat pump.

### BRIEF DESCRIPTION OF THE DRAWINGS

FIG. 1 shows an example of embodiment of a system to which a rotary drive device according to the invention may be applied;

FIG. 2 shows an example of embodiment of a gear train in combination with a motor.

FIG. 3A-FIG. 3C show an example of a rotary distributor that may be implemented in a system according to the invention;

FIG. 4 shows an example of embodiment of a rotary drive device, according to the invention for a rotary distributor.

FIG. 5A-FIG. 5D shows another example of embodiment of a rotary drive device according to the invention for a rotary distributor.

FIG. 6 shows an exploded view of a clutch or clutch release mechanism of a rotary drive device according to the invention.

### DETAILED DISCLOSURE OF PARTICULAR EMBODIMENTS

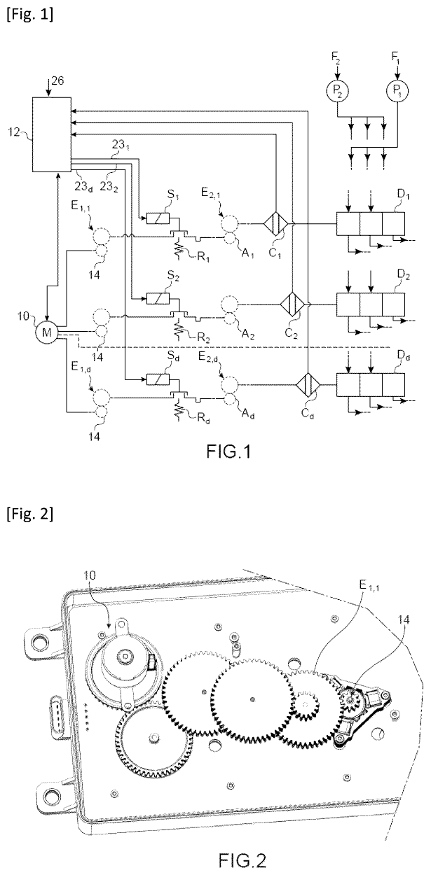

FIG. 1 shows an example of embodiment of a system or hydraulic circuit for distributing fluid(s), a rotary drive device according to the invention that can be applied to a rotary distributor and/or to one or more gears of such a system.

In this example, the hydraulic circuit comprises 2 pumps P1 and P2, each distributing a fluid F1, F2, but a different number of pumps and fluids forms part of the scope of the present application. The fluid(s) is/are distributed by rotary distributors Dᵢ, for example of the type according to the invention and/or as described later.

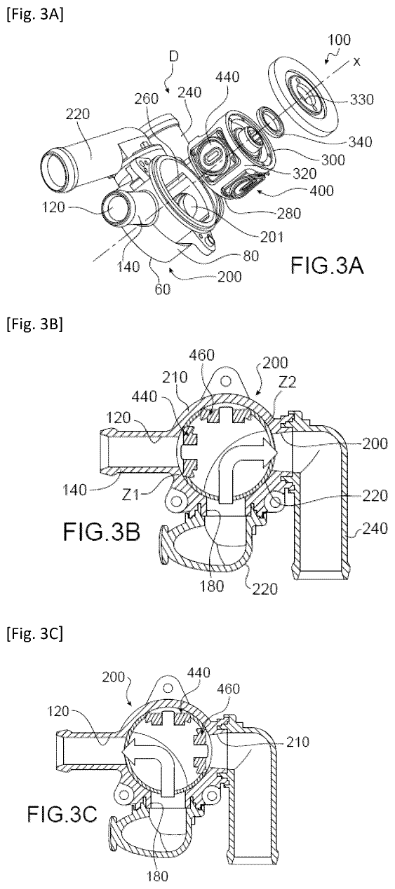

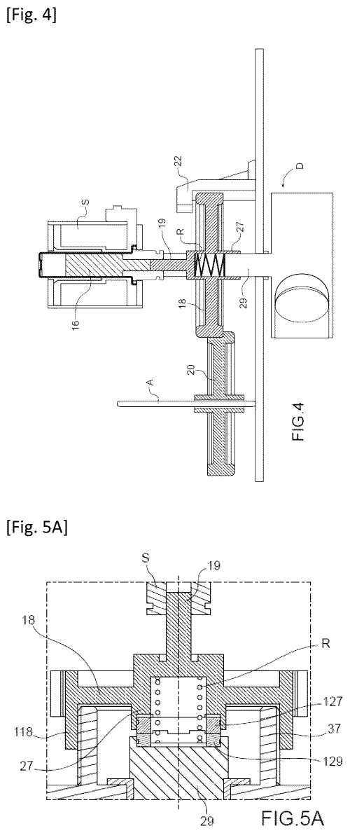

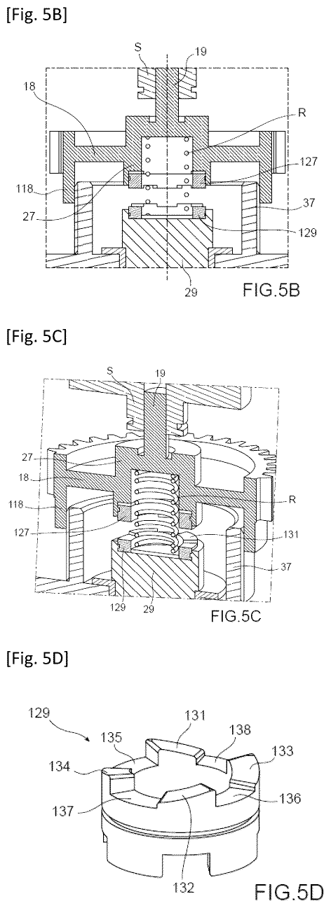

FIGS. 3A, 3B and 3C are described below and show one example of rotary distributor Dᵢ that can be used within the scope of the present invention. FIG. 4 and FIGS. 5A-5D, described below, show examples of novel drive means according to the invention, including a clutch and clutch release mechanism, to drive a rotary distributor, for example such as that in FIGS. 3A, 3B and 3C, or to drive another rotary member.

A system for controlling the distribution of fluids in the hydraulic circuit illustrated in FIG. 1 comprises a motor 10, preferably brushless, which drives a central output shaft 14 simultaneously coupled with d gear trains (d≥2).

FIG. 1 shows the shaft 14 associated with various gear trains, but the latter are in fact disposed about the shaft 14 (as in the example of FIG. 2 for a gear train). Electronic control means 12, for example produced in the form of a printed circuit board (PCB), control this motor 10. The gears of the various trains are preferably spur gears, with parallel shafts.

Each gear train comprises in this example a first gear (E_{1.1} . . . E_{1.d}) of a first gear stage.

Each of these gears E_{1.1} . . . E_{1.d} rotates for example a shaft A₁ . . . A₁ that is independently engageable/disengageable from the others, using an actuator, for example of the electromagnetic (solenoid) or pneumatic or hydraulic type. FIG. 1 schematically shows electromagnetic actuators (or solenoids) S₁, . . . S_{d} but other types of actuators can be implemented (hydraulic, pneumatic). Each disengageable shaft may be held in idle position for example by a compression spring, R₁, . . . R_{d}. Each actuator may be controlled by the electronic control means 12.

FIG. 4 is described below and shows a clutch and clutch release mechanism according to the invention for, for example, a rotary distributor Dᵢ. This mechanism here comprises an actuator of the electromagnetic type, comprising a solenoid Sᵢ, but, once again, other types of actuators can be implemented (hydraulic, pneumatic).

In the example of embodiment illustrated in FIG. 1, the system comprises a second stage of d gears (E_{2.1} . . . E_{2.d}). Each of these gears of the second stage may be connected to a disengageable shaft and drives a rotary distributor D₁ . . . D_{d}. These d rotary distributors are therefore driven independently of one another.

It can be noted that the actuator may be associated with any of the gear wheels or shafts for each gear train; in FIG. 1, this is the wheel that immediately precedes the distributor, but in FIG. 4 this is the wheel associated with the distributor itself. Any gear wheel of each gear train may be associated with the clutch and clutch release means, which makes it possible to disengage or engage the corresponding distributor. Each of the d distributors may be associated with a position sensor C₁-C_{d} that makes it possible, preferably at any time, to know the position of the distributor with which it is associated. A position signal is sent to the means 12.

Each rotary distributor Dᵢ comprises nₑᵢ inlets (nₑᵢ>1) and nₛᵢ outlets (nsᵢ>1) a distributor with a single inlet (nₑᵢ=1) comprising a plurality of outlets (nₛᵢ≥2) and a distributor with a single outlet (nₛᵢ=1) comprising a plurality of inlets (nₑᵢ>1). The outlets are connected to ducts that carry the fluid to a given application, for example a cooling circuit or a circuit that must be supplied with oil or air (for example an air conditioning circuit) or with hydrogen (for example a fuel cell supply circuit). In the example of FIG. 1, the distributor D₁ has one inlet and 2 outlets, the distributor D₂ has 2 inlets and one outlet, the distributor D_{d} has 2 inlets and 3 outlets; any other combination of inlets/outlets may be produced.

In FIG. 1, the outlets of the distributors are directed towards other members of the hydraulic system; but, alternatively (not shown), one or more outlets of one or more distributors are directed towards one or more inlets of another one or more other distributors.

One example of rotary distributor that can be implemented within the scope of the present invention is described in the application filed under the number FR-202101137; the structure thereof is reminded in FIGS. 3A, 3B and 3C, see the explanations below. The fluid distribution system moreover comprises a number p (p>1) of pumps, connected to the various distributors according to an architecture that is specific to the fluid distribution system considered.

Each of the d actuators S₁, . . . S_{d} may be controlled by the means 12 depending on the position of the various distributors; this position may be known thanks to the signal received by these means 12 from the corresponding position sensor.

During operation, the means 12 receive an operating mode instruction 26 from the vehicle, each operating mode is defined by the engaged or disengaged state of each distributor and by the opening and closing positions of all of the inlets and/or of all of the outlets of the distributors selected (or engaged). When all of the distributors have the same number x of possible positions, the total number of modes is equal to X^{t}. The data relating to each operating mode may be stored in memory means associated with the means 12 and the position of each distributor may be known by the sensors Cᵢ. The selection of an operating mode therefore defines an engaged or disengaged state of each distributor and/or a position for each engaged distributor. Optionally, the memory means may store (or even the means 12 may calculate):
in which direction and/or with which angular displacement each selected distributor may be actuated to make it change from one state defined by a certain combination of the inlets/outlets thereof to another state defined by another combination of the inlets/outlets thereof;
and/or the order in which the selected distributors must be engaged; all may be engaged simultaneously or sequentially (and this in a certain order) or even one part of these distributors may be engaged simultaneously, the other part being engaged sequentially (here again according to a certain order).

When one or more distributors must be driven in a direction opposite to the direction in which this or these distributor(s) were driven beforehand, then the direction of rotation of the motor 10 is reversed. The distributors the direction of rotation of which is not reversed may be disengaged. When one or more distributors must be driven in a direction opposite to the direction in which one or more other distributors must be driven, then it is possible to disengage the latter.

Depending on the selected operating mode, these means 12 may actuate the clutch or clutch release means of the selected distributor(s), and actuate this or these distributor(s) by delimiting for example the direction and the angular displacement of each of the distributors concerned, and/or the order or the activation sequence (sequential or simultaneous as described above).

The motor 10 is then powered, and depending on the determined sequence and/or the position of each of the d distributors, the shafts are engaged (or not) sequentially or simultaneously until each of the d distributors has reached the desired position. This system therefore makes it possible to replace a product consisting of a plurality of valves controlled by as many brushless actuators with a set of hydraulic distributors controlled by a single motor 10, for example brushless or stepper, and a clutch and clutch release mechanism associated with each distributor.

The means 12, produced for example in the form of a printed circuit board, may comprise for example a processor or a micro-processor programmed to control the clutch/clutch release means of each distributor and/or the motor 10 according to a plurality of operating modes as defined above and/or to calculate the actuation of one or more of the distributors depending on an operating mode selected by an operator or a vehicle. FIG. 2 shows one example of embodiment of a single gear train in combination with a motor 10. The shaft 14 of the motor, as well as the first stage E_{1.1} can be seen in this figure. Other gear trains identical or similar to that shown in FIG. 2 may be arranged around the motor. All of these elements are held or attached on a support 11. This support may for example be made of one or more distinct parts mechanically connected by welding and/or by a mechanical system and/or consist of one or more materials.

FIGS. 3A, 3B and 3C show an example of a rotary distributor that may be implemented in a system according to the invention.

It comprises one inlet and two outlets, but it is understood that it may comprise one or more inlets and one or more outlets.

This distributor comprises a valve body or housing 200, essentially of cylindrical shape revolving about an axis X, and a central part 400, designated as core, mounted in the housing 200 and capable of rotating in the housing 200.

In the example shown, the housing 200 comprises a bottom 60 and a side wall 80 substantially cylindrical in a single piece, and a cover 100 to close the housing. The cover 100 is for example secured to the housing 200 by welding, for example by ultrasonic welding.

The housing 200 comprises an orifice 180, referred to as supply orifice, formed in the side wall 80 and a supply duct 220, for example welded on the base of the orifice 180 and intended to connect to a fluid source, for example a pump such as one of the pumps P1, P2 of FIG. 1. On either side of this inlet orifice 180, the housing 200 also comprises:
a first outlet orifice 210 formed in the side wall 80, extending by a duct 240 intended to carry the liquid to a given area, for example an area to be cooled;
and a second outlet orifice 120 extended by a duct 140, intended to carry the liquid to another given area.

The ducts 140 and 240 are for example welded on the base of the orifices 210 and 120 respectively. The housing 200 defines a hydraulic chamber 260. The outlet orifices 120 and 210 are angularly distributed over the side wall about the axis X on either side of the supply orifice 180.

The core 400 is intended to be mounted in the hydraulic chamber and is capable of rotating about the axis X. It comprises two end faces 280, 300 and a lateral surface 320.

The end face 280 is facing the bottom of the housing and the end face 300 is facing the cover. The end face 300 comprises a hollow indentation 310 intended to receive the end of a shaft of an actuator, shaft preferably aligned along the axis X. The cover 100 comprises an opening 330 facing the indentation 310 to make it possible to couple it with the shaft. Alternatively, the end face 300 comprises a protruding coupling member intended to penetrate into a hollow indentation formed in the shaft of the actuator. A seal 340 is advantageously provided between the end face 300 and the cover bordering the indentation 310 to prevent fluid leakages.

The core 400 also comprises a first seal 440 intended to seal the outlet orifice 120, when they are facing, and a second seal 460 and intended to seal the outlet orifice 210, when they are facing. The first seal 440 and the second seal 460 are of identical or similar shape, as well as the mounting thereof on the core.

FIG. 4 shows a mechanism for driving a rotary distributor D, for example of the type described above in relation to FIG. 3A, 3B, 3C, equipped with an output shaft 29, and the actuator thereof, here of the electromagnetic type; the latter comprises a solenoid S that, when actuated, actuates a plunger 16, which has magnetic properties for interacting with the field generated when a current flows through the solenoid and that will compress the compression spring R. The plunger thus pushes a shaft 19 secured to a gear wheel 18, which then engages with another wheel 20, mounted on a shaft A, itself actuated by the motor 10, or by drive means (this wheel itself forms part of a gear train) driven by the motor 10. The wheel 18 is extended in the central part thereof by a compartment or a cylindrical wall 27, which comprises means (keys for example) that enable it to be coupled to the output shaft 29 of the distributor, while making possible a translation of the assembly comprising the wall 27, the wheel 18 and the shaft 19, relative to the shaft 29. When the plunger has pushed the shaft 19 towards the distributor D, the latter is engaged. When the action of the solenoid is released, the spring R pushes back the assembly 18-19-27 that then changes into clutch release. The device may further comprise a brake 22 that makes it possible to brake the distributor (the gear wheel 18) when the latter is disengaged. The solenoid may be controlled by means such as the means 12 described above. Such a rotary distributor D may be used in a system as described above in relation to FIGS. 1 and 2. The rotary distributor here is rotated in a plane that is perpendicular to the output shaft thereof.

FIGS. 5A, 5B, 5C, 5D show a variant of the drive means, including a clutch and clutch release mechanism, for example of a rotary distributor D, for example of the type described above in relation to FIGS. 3A, 3B, 3C; in these FIGS. 5A, 5B, 5C, 5D numerical references identical to those of the preceding figures, in particular FIG. 4, designate the same elements.

The gear wheel 18 is extended in the lateral part thereof by a skirt 118, preferably located at the periphery of the wheel, which cooperates with a centring support 37 attached to the support 11. For example, the centring support 37 guides the inner surface of the wall 118 that, on the outer surface thereof, bears the teeth of the wheel.

The clutch means comprise a dog system 127, 129 (or teeth and groove coupling device) one part 127 of which is for example disposed at the end of the compartment or of the cylindrical wall 27 and the other part 129 is preferably disposed at the end of the output shaft 29 of the distributor. A more detailed representation of the part 129 is shown in FIG. 5D, with the teeth 131-134 thereof and the grooves 135-138 thereof that make it possible to receive the teeth of the part 127 when these 2 parts are engaged, the teeth 131-134 themselves being slotted into corresponding grooves of the part 127. The other part 127 therefore comprises corresponding teeth and grooves. When these 2 parts are engaged, the output shaft 29 of the distributor can be driven by the wheel 18. The number of teeth shown in FIG. 5D is 4, but a different number may be provided. In this variant of FIGS. 5A-5D, the translational movement, along the shaft 19, is guided laterally by the means 37 and 118, at a distance from the shaft 19, whereas the coupling of the wheel 18 with the body 400 of the distributor is ensured centrally.

The actuator S may therefore actuate the plunger 16, which thus pushes the shaft 19 in translation, which shaft is secured on the one hand to the tooth 18, and on the other hand to the means 127. Thus, it is possible:
on the one hand to mesh the wheel 18 with, for example, another wheel 20, mounted on a shaft A (as in FIG. 4), itself actuated for example by the motor 10, or by drive means (this wheel itself forms part of a gear train) driven by the motor 10;
on the other hand to engage the shaft 19 with the shaft 29 of the distributor.

Consequently, when the plunger has pushed the shaft 19 towards the distributor D, the latter is engaged (FIG. 5A) and can be actuated to guide a fluid from an inlet to an outlet of the distributor. When the action of the solenoid S is released, the compression spring R pushes back the assembly 18-19-27-127 and the distributor D changes into clutch release (FIG. 5B, the two parts 127, 129 of the clutch means being disengaged). FIG. 5C shows another view of the disengaged position.

As in FIG. 4:
the rotary distributor (or, more generally, the rotary member) may be rotated in a plane that is perpendicular to the output shaft thereof;
and/or the device may further comprise a brake that makes it possible to brake the distributor (and/or the gear wheel 18) when the latter is disengaged;
and/or the solenoid S may be controlled by means such as the means 12 described above;
and/or the rotary distributor may be used in a system as described above in relation to FIGS. 1-3C.

Relative to FIG. 4, the device shown with FIGS. 5A, 5B, 5C, 5D makes less wear possible in particular of the teeth of the gear; the latter may be made of plastic, for example PPA or PPS, the clutch system described above in relation to FIGS. 5A, 5B, 5C, 5D may be metal, for example steel.

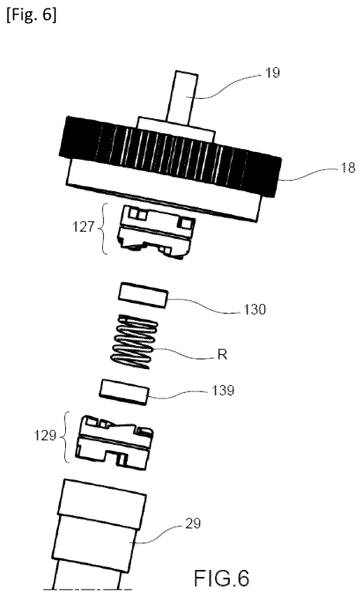

FIG. 6 shows an exploded view of the shaft 19, of the wheel 18 and of clutch/clutch release elements with the shaft 29; the references 130 and 139 designate respectively an upper spring flange and a lower spring flange. It shows the upper 127 and lower dogs 129 intended to be attached respectively to the shaft 19 of the actuator and to the rotation shaft 29.

FIGS. 4 and 5A, 5B, 5C, 5D show mechanisms for driving a rotary distributor D. But one of these mechanisms can be applied to drive another rotary member, equipped with a shaft 29, preferably perpendicular to the plane in which the rotary member may be rotated; this other rotary member is for example another gear wheel, for example in a gear stage such as one of those described above in relation to FIG. 1 or 2. One of these drive mechanisms may therefore be used to drive a gear stage, itself driving for example another gear stage or one or more distributor(s).

An application of a device or of a system according to the invention relates to the distribution of a flow of cooling water in a cooling circuit of a vehicle. But other applications may be concerned, for example the distribution of oil or of gas (for example of air or of hydrogen) in a vehicle (car or truck, with a combustion or electric or hybrid engine; or a boat or a flying machine), or even the distribution of a fluid in a domestic application, for example a heat pump.

In a system or hydraulic circuit for distributing fluid(s) as described above and/or in relation to FIG. 1 or 2, each gear train may comprise at least two gear stages:
a first gear stage E_{1.1}-E_{1.d}, each gear of which is driven by said motor 10;
a second gear stage E_{2.1}-E_{2.d}, each gear of which is driven by the first stage, at least one gear of the first gear stage and/or of the second gear stage and/or at least one, for example each, distributor being equipped with means S₁-S_{d} for engaging it or disengaging it.

In a system or hydraulic circuit for distributing fluid(s) as described above and/or in relation to one at least of the figures, comprising electronic means 12 for controlling the motor 10, these electronic means 12 may be capable of:
receiving an operating mode instruction 26;
determining a target position of each of the d rotary distributors;
controlling the motor 10 and/or the means for engaging or disengaging each rotary distributor depending on the target position of each of the rotary distributors. In a device or a system or hydraulic circuit for distributing fluid(s) as described above and/or in relation to one at least of the figures, the means for engaging or disengaging each rotary distributor, or each rotary member, may comprise an actuator, for example of the electromagnetic (S₁, . . . S_{d}) or pneumatic or hydraulic type.

The invention also applies to a method for controlling the distribution of a fluid in a system or hydraulic circuit for distributing fluid(s) as described above and/or in relation to one at least of the figures, for example in a vehicle, this method comprising:
selecting one or more rotary distributors (D₁-D_{d}) to be actuated;
actuating said distributor(s) (D₁-D_{d}) using the motor (10) and/or means for engaging this or these distributor(s).

Such a method may comprise selecting or determining a direction and/or an angle of rotation of one or more distributors to be actuated and actuating said rotary distributor(s) according to this direction and/or this angle of rotation.

In such a method:
the fluid is for example water or oil or glycol or a gas, for example water or hydrogen;
and/or the hydraulic circuit is a cooling circuit or circuit for distributing oil or hydrogen of a vehicle.

1-26. (canceled)

27. System for controlling the distribution of one or more fluids in a fluid circuit, comprising:
a motor;
a plurality of d rotary distributors of said fluid;
a plurality of d gear trains, each train transmitting the movement from the motor to one of the rotary distributors, referred to as associated rotary distributor, each gear train comprising means for engaging or disengaging a gear of this train, or the associated rotary distributor, relative to the gear train, these means for engaging or disengaging a gear of this train, or the associated rotary distributor, comprising at least one rotary drive device for a rotary member equipped with an output shaft, said drive device comprising:
a gear wheel, rotating about a rotation shaft aligned with the output shaft;
an actuator for actuating the rotation shaft of the gear wheel towards the output shaft of said rotary member;
guide means of the gear wheel so as to guide the translation movement thereof along the rotation shaft;
clutch means of the rotation shaft and of the output shaft comprising a coupling device using teeth and grooves.

28. System according to claim 27, the rotary drive device comprising return means for holding the clutch means of the rotation shaft and of the output shaft in the disengaged position, said actuator compressing these return means (R) to engage the rotation shaft and the output shaft.

29. System according to claim 28, said return means being disposed at least partly in a compartment one end of which is equipped with a part of the clutch means.

30. System according to claim 28, said actuator being of the electromagnetic actuator type, comprising a coil and a plunger that interacts with the field generated by the coil when a current flows through the latter, in order to compress the return means.

31. System according to claim 27, said guide means of the gear wheel comprising a centring support that guides the inner surface of the wall of the gear wheel.

32. System according to claim 27, said actuator being of the electromagnetic or pneumatic or hydraulic type Or being of the electromagnetic type and comprising a coil and a plunger that interacts with the field generated by the coil when a current flows through the latter.

33. System according to claim 27, further comprising at least one
means for driving the wheel, forming with the latter a vertical shaft gear;
a brake for braking the rotary member when the latter is disengaged;

34. System according to claim 27, said rotary member being a rotary distributor comprising a rotary distributor body, comprising at least one inlet and at least one outlet, the sum of the number of inlets and of the number of outlets being greater than or equal to 3.

35. System according to claim 27, the rotary member comprising a gear wheel.

36. System according to claim 27, each gear train comprising at least two gear stages:
a first gear stage, each gear of which is driven by said motor;
a second gear stage, each gear of which is driven by the first stage,
a gear being equipped with means for engaging it or disengaging it.

37. System according to claim 27, each rotary distributor comprising a position sensor.

38. System according to claim 27, comprising electronic means for controlling the motor.

39. System according to claim 37, further comprising electronic means capable of controlling the motor depending on one or more signals from one or more of said position sensors.

40. System according to claims 38, the electronic means being capable of:
receiving an operating mode instruction;
determining a target position of each of the d rotary distributors;
controlling the motor and/or the means for engaging or disengaging each rotary distributor depending on the target position of each of the rotary distributors.

41. System according to claim 27, the fluid circuit being a circuit for distributing one or more fluids in a thermal management circuit, or a circuit for distributing oil, dielectric fluid or hydrogen or air of a vehicle.

42. System according to claim 27, the motor being a brushless motor.

43. System according to claim 27, the means for engaging or disengaging each rotary distributor comprising an actuator, for example of the electromagnetic or pneumatic or hydraulic type.

44. System for distributing one or more fluids in a fluid circuit, comprising:
at least one pump;
a system for controlling the distribution of said fluid according to claim 27.

45. Vehicle comprising an engine, combustion or electric, at least one fluid circuit and at least one system for distributing at least one fluid in this circuit according to claim 18.

46. System according to claim 27, wherein the fluid is water or oil, or a dielectric fluid, or a mixture comprising glycol or a gas, for example air or hydrogen.
